(19) United States
(12) Patent Application Publication
(10) Pub. No.: US 2025/0300580 A1
(43) Pub. Date: Sep. 25, 2025

(54) Method for operating a circuit arrangement for BEMF zero crossing identification

(71) Applicant: Hilti Aktiengesellschaft, Schaan (LI)

(72) Inventor: Justus FREISCHLE, Landsberg (DE)

(21) Appl. No.: 18/862,738

(22) PCT Filed: May 15, 2023
(86) PCT No.: PCT/EP2023/062938

§ 371 Date: Nov. 4, 2024

(30) Foreign Application Priority Data
May 31, 2022 (EP) 22176268.5

(51) Int. Cl. H02P 6/182; H02P 6/08; H02P 6/15

(52) U.S. Cl. CPC H02P 6/182; H02P 6/085; H02P 6/157

(57) ABSTRACT

Method for operating a circuit arrangement as part of a BEMF zero crossing identification operation, which serves as the basis for sensorless commutation of a brushless DC motor, wherein the circuit arrangement has at least one comparator and a microcontroller, wherein the comparator is designed to compare a phase voltage or terminal voltage of the brushless DC motor with a star point voltage (reconstructed via the terminal voltages or directly tapped off) of the brushless DC motor and to output a corresponding comparator signal to a signal path of the microcontroller, which signal path is connected to the comparator, wherein the signal path of the microcontroller and/or microcontroller pin, which signal path is connected to the comparator, is periodically switched over between an input mode and an output mode.

The present invention relates to a method for operating a circuit arrangement as part of a BEMF zero crossing identification operation.

In the text which follows, the voltage between a motor terminal and the ground of the upstream motor inverter is referred to as the terminal voltage.

The star point voltage is reconstructed via the terminal voltages or directly tapped off.

### BACKGROUND

In the case of sensorless commutation, the BEMF zero crossing identification method has already been used for some time to determine the commutation time. The property of 2-FET block commutation that—by way of example—always only two of the three available motor phases of the brushless DC motor are energized at the same time is utilized here. Therefore, the induced voltage in the third phase, caused by the permanent magnets embedded in the rotor of the brushless DC motor, can be measured. This is performed by the comparators described in the previous paragraph.

U.S. Pat. No. 8,274,250 discloses a control method for a brushless DC motor, with a back electromotive force (BEMF) being detected depending on a masking signal.

### SUMMARY OF THE INVENTION

It is an object of the present invention to provide a method for operating a circuit arrangement as part of a BEMF zero crossing identification operation, which method promotes reduced utilization of the microcontroller and at the same time enables more precise position tracking.

The present invention provides that the signal path of the microcontroller, which signal path is connected to the comparator, is periodically switched over between an input mode and an output mode. In the later text, reference is always made to the comparator, which is currently connected to a motor terminal that is not energized. In the following text, this comparator is also referred to as an active comparator. In the input mode, a pin of the microcontroller, which pin is connected to the signal path of the microcontroller, is preferably configured as an input in order to evaluate a comparator signal of the comparator. In the output mode, a pin of the microcontroller, which pin is connected to the signal path of the microcontroller, is preferably configured as an output in order to condition the microcontroller signal path and thus likewise the microcontroller pin with a specific digital signal level. It has been found to be advantageous if the sensorless commutation is carried out as block commutation.

The present invention also provides that a comparator signal can be detected in two different ways by means of a microcontroller. Either the comparator signal can be sampled at fixed time intervals (polling) or a microcontroller periphery (generally interrupts) can be used to react directly to a signal edge of the comparator. It has been found that polling at high speeds of the brushless DC motor—for example starting from 60000 rpm in the electrical reference system—can lead to undesirably high angle errors. With regard to detection by means of interrupts, it was recognized that many types of microcontroller provide only edge-controlled interrupts. However, edge detectors, which trigger the generation of the interrupts within the microcontroller, cannot be deactivated in most cases. Therefore, in unfavorable cases, there could be no falling or rising edge of the comparator signals to be detected within the valid PWM (Pulse Width Modulation) section since the zero crossing took place in a previous invalid time period. Consequently, no interrupt would be generated and thus no commutation would be carried out. This would, in turn, lead to failure of the motor controller.

The fact that, according to the invention, a signal path of the microcontroller, which signal path is connected to the comparator, is periodically switched over between an input mode and an output mode creates a basis for avoiding the disadvantages mentioned.

In the context of the present application, a BEMF zero crossing is to be understood in particular as a point at which the terminal voltage of the non-energized motor phase intersects with the star point voltage of the motor (reconstructed via the terminal voltages or directly tapped off) in the correct direction appropriately for the current rotor position sector.

In the context of the present application, a valid time period is considered to be, in particular, a time period in which the output signal profile (comparator signal) of the BEMF zero crossing comparator correctly reflects the relationship between the BEMF of the non-energized phase and the star point voltage (reconstructed via the terminal voltages or directly tapped off). An invalid time period is, in particular, a time period in which the output signal profile (comparator signal) of the BEMF zero crossing comparator reflects the relationship between the BEMF of the non-energized motor phase and the star point voltage (measured or reconstructed) with an incorrect signal level.

In a particularly preferred configuration of the method, provision is made for a pin of the microcontroller, which pin is connected to the signal path of the microcontroller, to be configured as an input in the input mode in order to evaluate the comparator signal of the comparator for the BEMF zero crossing identification. It has been found to be advantageous if the pin of the microcontroller, which pin is connected to the signal path of the microcontroller, is configured as an output in the output mode in order to be able to correctly condition the signal level at the pin of the microcontroller during the invalid PWM time periods for the edge detector in the microcontroller.

According to a further advantageous embodiment, it is possible, while the pin of the microcontroller is in the output mode, for the signal path of the microcontroller and the comparator output signal to be able to have the same or a different signal level.

In a particularly preferred configuration, the conditioning level for the microcontroller pin in the output mode is a logic “high” or “low” level. The voltages of the levels are defined by the supply voltage of the microcontroller.

It has been found to be advantageous if the comparator is arranged outside the microcontroller and an ohmic resistor is provided between a comparator output of the comparator, which comparator output outputs the comparator signal, and a pin of the microcontroller, which pin is connected to the signal path.

In a particularly preferred configuration, the switching over between the input and output mode takes place synchronously with a PWM carrier signal of the motor controller of the brushless DC motor and/or as a function of a duty cycle of the motor controller of the brushless DC motor. This switching over is referred to as signal conditioning in the text which follows. It has been found to be advantageous if the microcontroller pin is configured as an output (output mode) for longer than the invalid time range of a PWM period.

In a further particularly preferred configuration, the method comprises, in addition to the signal conditioning already described, the following steps as part of the sensorless commutation of the brushless DC motor:
deactivating the edge-related interrupt trigger of the microcontroller and/or deactivating an external interrupt of the microcontroller pin, which is associated with the signal path of the microcontroller, of the motor terminal that is currently not energized if a commutation operation to be carried out is identified;
setting a new power switch combination for the brushless DC motor in order to be able to establish appropriate energization for the current rotor position sector of the brushless DC motor;
deactivating the interrupt activated in the previous step as soon as it is identified that the inactive motor phase is de-energized; and reconfiguring the interrupt trigger to either a rising or falling edge depending on the current rotor position sector to detect the BEMF zero crossing. The reconfigured interrupt is then activated.
As long as the sensorless commutation based on BEMF zero crossing identification is active, this method is executed and the signal conditioning for the edge detector of the microcontroller pin is always executed as described.

It has been found to be advantageous if the steps are carried out in this order. In a particularly preferred configuration, the method steps mentioned are repeated after successful detection of a BEMF zero crossing, starting with the first method step, in particular for as long as the brushless DC motor is intended to be operated in a BEMF mode.

According to an advantageous embodiment, it may be possible for the following method step to be included:
switching over the active comparator to that associated with the currently non-energized motor terminal and therefore likewise the signal path of the microcontroller and the associated microcontroller pin and activating the already described signal conditioning for this microcontroller pin with subsequent selection of whether an interrupt of the microcontroller, which identifies the end of the off-commutation, should be triggered on a rising or falling signal edge, followed by activation of this interrupt.

Sensorless commutation of a brushless DC motor is likewise provided by a circuit arrangement for BEMF zero crossing identification. The circuit arrangement has at least one comparator and a microcontroller, wherein the comparator is designed to compare a phase voltage or terminal voltage of the brushless DC motor with a star point voltage (reconstructed via the terminal voltage or directly tapped off) of the brushless DC motor and to output a corresponding comparator signal to a signal path of the microcontroller. The microcontroller is designed to periodically switch over the signal path between an input mode and an output mode.

It has been found to be advantageous if the comparator is arranged outside the microcontroller and/or an ohmic resistor is provided between a comparator output of the comparator, which comparator output outputs the comparator signal, and a pin of the microcontroller, which pin is connected to the signal path. In an alternative configuration, the comparator can be arranged within the microcontroller and an ohmic resistor can be connected upstream of a comparator input of the comparator.

The invention likewise leads to an electric handheld power tool having a brushless DC motor, which is preferably of three-phase design, in combination with a type of commutation which is suitable for sensorless commutation of the brushless DC motor. It has been found to be advantageous if the handheld power tool has at least one circuit arrangement of the type described above. It has likewise been found to be advantageous if the circuit arrangement executes the method of the type described above at least temporarily.

Further advantages can be found in the following description of the figures. A particularly preferred exemplary embodiment of the present invention is depicted in the figures. The figures, the description and the claims contain numerous features in combination. A person skilled in the art will expediently also consider the features individually and combine them to form useful further combinations.

### BRIEF DESCRIPTION OF THE DRAWINGS

Identical and similar components are denoted by the same reference signs in the figures, in which:

FIG. 1 shows a preferred circuit arrangement for BEMF zero crossing identification;

FIGS. 2A, 2B, 2C are graphs containing voltage curves of a BLDC motor which is operated with 2FET commutation;

FIGS. 3A, 3B, 3C are graphs containing a signal profile which shows periodic switching over between an input mode and an output mode;

FIGS. 4A, 4B, 4C are graphs containing an output level, which is required during the invalid time period, of the microcontroller pin;

FIGS. 5A, 5B, 5C are graphs with signal profiles in which only two signal edges are generated at the microcontroller pin per commutation section; and

FIG. 6 shows a preferred method for sensorless commutation of a brushless DC motor.

### DETAILED DESCRIPTION

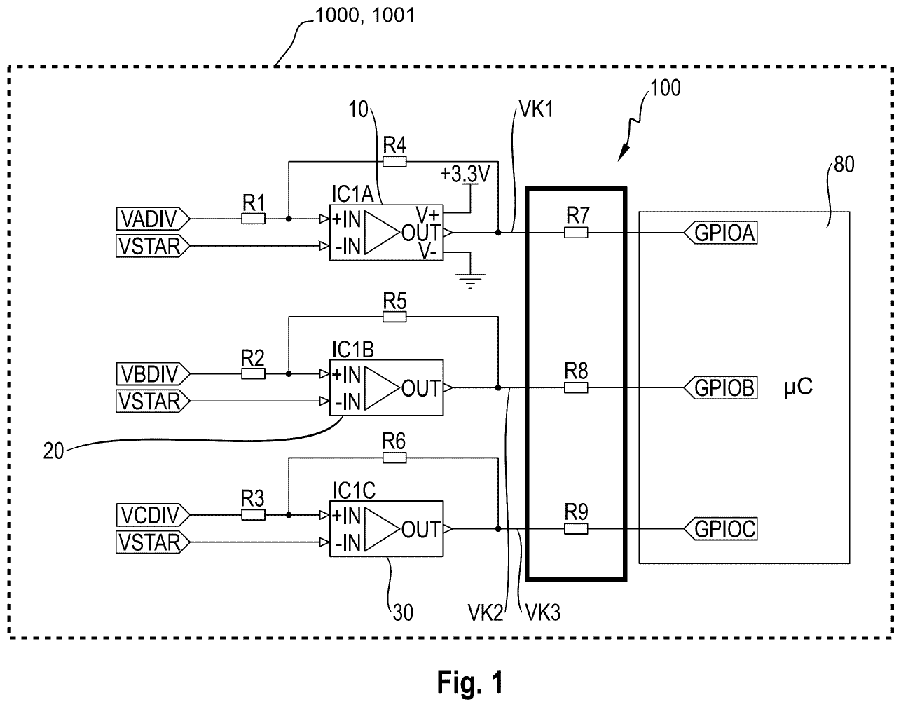

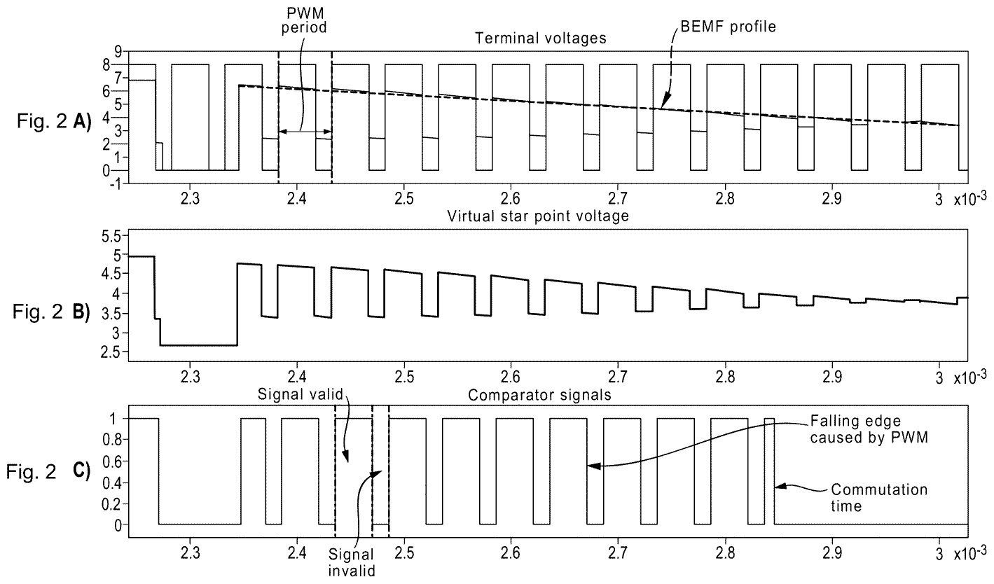

FIG. 1 schematically shows a circuit arrangement 100 for BEMF zero crossing identification for a brushless DC motor, shown solely schematically as 1000 here, with three phases, which is commutated by a bridge with two FETs per phase. The circuit arrangement 100 has three comparators 10, 20, 30 and a microcontroller 80. The comparators 10, 20, 30 are designed to compare a phase or terminal voltage VADIV, VBDIV, VCDIV of the brushless DC motor in each case with a star point voltage (reconstructed via the terminal voltages or directly tapped off) VSTAR of the brushless DC motor, to generate a corresponding comparator signal VK1, VK2, VK3 and to output this comparator signal to a respective signal path GPIOA, GPIOB, GPIOC of the microcontroller 80. The comparators 10, 20, 30 are used to detect the point at which the terminal voltage of a non-energized motor phase (in which, in FIGS. 2 to 5, the phase voltage VBDIV of the B-phase to which a bridge current is not applied) of the brushless DC motor intersects the star point voltage (reconstructed via the terminal voltages or directly tapped off) VSTAR. The comparators 10, 20, 30 change their comparator signal VK1, VK2, VK3 depending on the BEMF edge direction either from “low” to “high” or from “high” to “low”. It has to be possible for the microcontroller 80 to be able to detect these signal edges as precisely as possible in order to ensure uniform commutation.

According to the invention, the microcontroller 80 is designed to periodically switch over the signal path GPIOA, GPIOB, GPIOC between an input mode and an output mode. This will be explained in more detail later with reference to FIGS. 2 to 5.

As can be gathered from FIG. 1, the comparators 10, 20, 30 are arranged outside the microcontroller 80. For the purpose of limiting current in the case of an unequal output level of the microcontroller 80 (then in the output mode) and the active comparator 10, 20, 30, an ohmic resistor R7, R8, R9 is provided between a comparator output of the comparator 10, 20, 30, which comparator output outputs a comparator signal V1, VK2, VK3, and a pin of the microcontroller 80, which pin is connected to the signal path GPIOA, GPIOB, GPIOC.

As an alternative, the comparator can be arranged within the microcontroller and an ohmic resistor can be connected upstream of a comparator input of the comparator.

The circuit arrangement 100 of FIG. 1 can be part of an electric handheld power tool 1001 shown schematically, or part of another machine, such as a circular saw or construction vacuum cleaner for example.

FIG. 2A shows, by way of example, a graph containing signal profiles of the three terminal voltages (cf. FIG. 1 VADIV, VBDIV, VCDIV) of a BLDC motor which is operated with 2FET commutation. A commutation interval, in which the motor phase B is not energized, is shown by way of example in FIGS. 2 to 5. FIG. 2B shows the star point voltage (reconstructed via the terminal voltage) of the motor, and FIG. 2C shows the output signal profile (comparator signal) of the BEMF zero crossing comparator of the motor phase B (cf. FIG. 1, comparator 20).

In the graph of FIG. 2A, the profile of the BEMF is also shown as a dashed line. This clearly shows that only specific time intervals within a PWM period reflect the actual profile of the BEMF. The distortions of the BEMF are often so severe in the invalid time intervals that the comparator signal (cf. VK2 in FIG. 1) changes the signal state. If this comparator signal were now passed to an edge-controlled interrupt input, an interrupt would be triggered with each signal edge. The stored interrupt routine would have to decide whether there is an interrupt that was triggered by the distortion of the BEMF by the PWM or whether there is a real zero crossing of the BEMF. However, this would drastically increase processor utilization and make interrupt-based sensorless commutation practically impossible to implement.

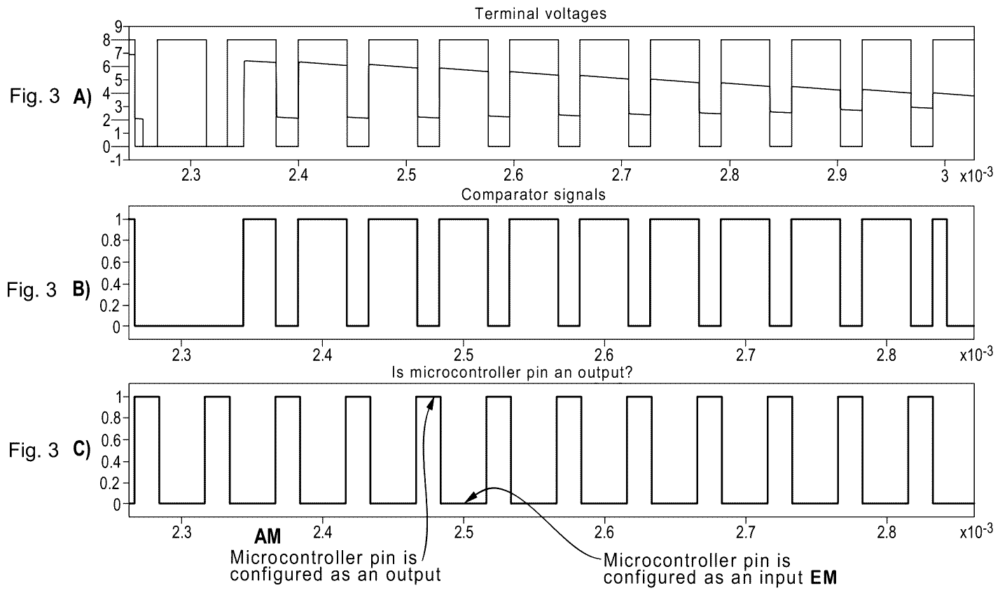

FIG. 3A shows the same signal profile as FIG. 2A. The signal profile of FIG. 2C is repeated in FIG. 3B. FIG. 3C now shows how-according to the invention-a signal path of the microcontroller, which signal path is connected to the comparator, is periodically switched over between an input mode EM and an output mode AM.

In the input mode EM, a pin of the microcontroller, which pin is connected to the signal path (cf. FIG. 1, “GPIOB”) of the microcontroller, is configured as an input in order to evaluate a comparator signal (cf. FIG. 2, VK2) of the comparator. In the output mode AM, the pin of the microcontroller, which pin is connected to the signal path of the microcontroller, is configured as an output in order to be able to correctly condition the signal level at the pin of the microcontroller during the invalid PWM time periods for the edge detector of the microcontroller pin. This creates the basis, just to generate a minimum of signal edges at the microcontroller pin. In the optimal case, only an interrupt which indicates that the inactive motor phase is de-energized, so that the BEMF can be detected, and an interrupt which detects the BEMF zero crossing, which in turn can be used to directly initiate the commutation, are generated.

In other words, the idea on which the method according to the invention is based is that a microcontroller pin now fulfils two tasks: During the valid time period within a PWM period, the microcontroller pin is connected as an input and thus detects the comparator signal currently present at the microcontroller. In those time periods of the PWM period in which the comparator signal is invalid, the microcontroller pin is defined as an output and thus conditions the level present at the edge detector of the microcontroller pin with its signal level.

If, as shown in FIG. 3C, the microcontroller pin is defined as an output (output mode AM), any level can be generated by the microcontroller pin during the invalid PWM time intervals. This is advantageously selected such that the edge detector of the microcontroller pin can detect the expected edge direction during the following valid time period. Since the course of the BEMF is deterministic and known, the output levels can be preconfigured for a commutation section. Based on the curve shown in FIG. 3C, the signal path (cf. FIG. 1, GPIOB) at the microcontroller has to have a “high” level in the invalid PWM time periods in order to prepare the edge detector for a falling edge in the valid PWM time period. Of course, the current comparator signal (cf. FIG. 1, VK2) cannot be detected within the period of time when the microcontroller pin is connected as an output. This leads to inaccuracies in the identification of the BEMF zero crossing. However, the invalid time interval becomes smaller and smaller as the duty cycle increases (higher load torque or higher speed), and therefore the commutation accuracy is increased. The microcontroller pin is particularly preferably configured as an output for longer than the length of the invalid time range of a PWM period. This prevents signal transients from leading to errors in the edge identification of the comparator signal.

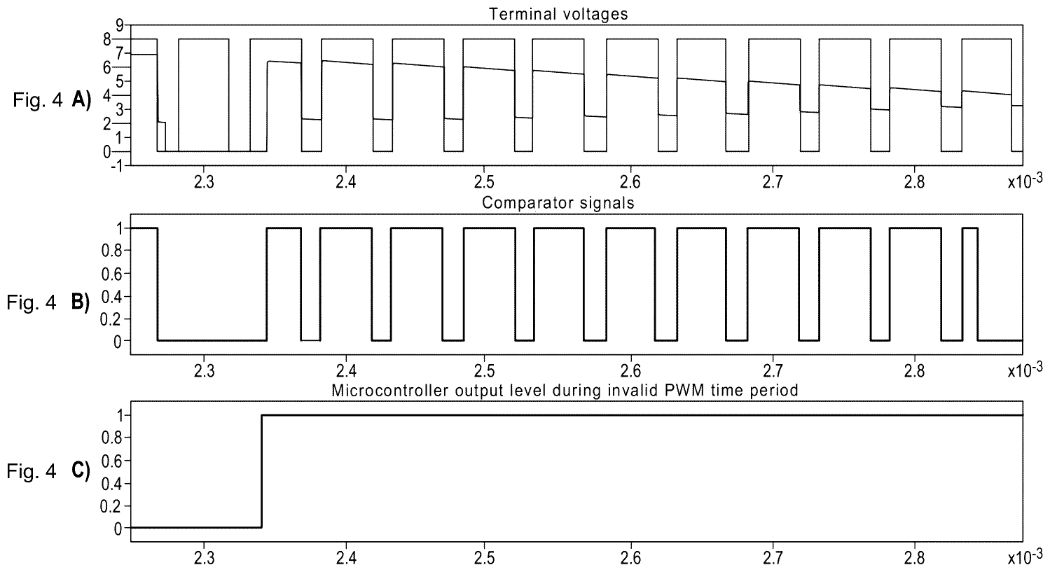

FIG. 4A shows the same signal profile as FIG. 3A. The signal profile of FIG. 3B is repeated in FIG. 4B. FIG. 4C now shows an example of a signal level required during the invalid PWM time period in order to be able to correctly condition the edge detector of the respective microcontroller pin or of the respective microcontroller signal path (cf. FIG. 1, signal path GPIOB).

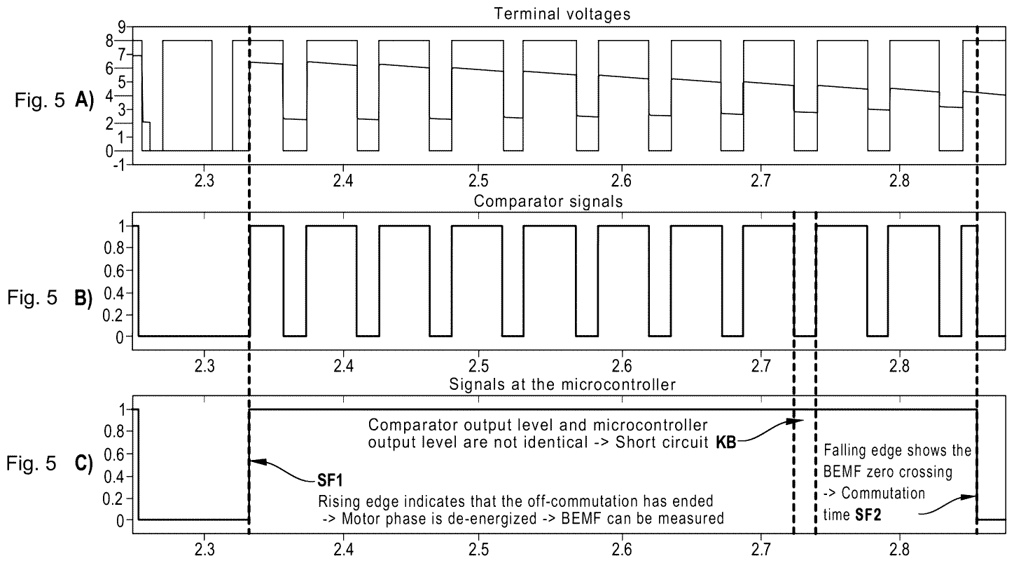

FIG. 5C finally shows the signal profile in the signal path resulting from the relationships described so far (cf. FIG. 1, signal path GPIOB) of the microcontroller or directly at the microcontroller pin. Due to the signal conditioning, only two signal edges are generated per commutation section. A first signal edge SF1 indicates that the non-driven motor phase is actually de-energized and a second signal edge SF2 indicates the BEMF zero crossing, which corresponds to the commutation time.

As can be gathered from FIG. 5C, the microcontroller output level (signal path of the microcontroller is in the output mode) does not correspond to the level of the comparator signal in the invalid PWM time periods (short-circuit range). This would mean shorting the microcontroller pin with the comparator output. In order to prevent this, as can be seen in FIG. 1, an ohmic resistor is provided in each case between a comparator output of the comparator, which comparator output outputs a comparator signal, and a pin of the microcontroller, which pin is connected to the signal path. This limits the current flowing in the case of an unequal output level of the microcontroller and the comparator.

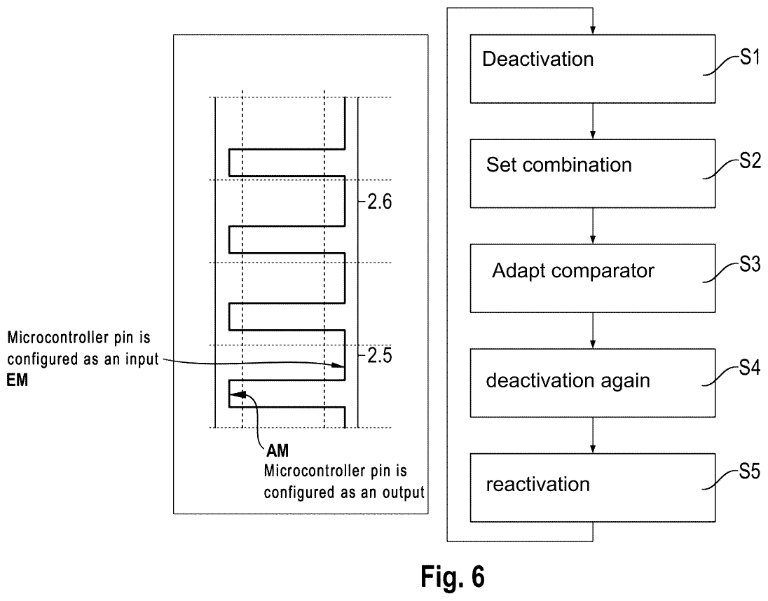

With reference to FIG. 6, a preferred method for sensorless commutation of a brushless DC motor including the timing of an interrupt-based commutation sequence is now described.

In a first step S1, the edge-related interrupt trigger of the microcontroller and/or the external interrupt associated with the signal path of the microcontroller of the motor terminal that is currently not energized is deactivated.

In a subsequent second step S2, a new circuit breaker combination is set in order to be able to produce the appropriate energization for the current rotor position sector of the BLDC motor.

In a subsequent third step S3, the active comparator is correspondingly adapted to the new rotor position sector and thus to the motor terminal that is currently not energized. This likewise results in a different microcontroller signal path. The signal conditioning already described for the current microcontroller signal path is then executed and a selection is made as to whether an interrupt of the microcontroller, which identifies the end of the off-commutation, should be triggered on a rising or falling signal edge. Finally, the associated interrupt is activated.

In a subsequent fourth step S4, as soon as it is identified that the inactive motor phase is de-energized (this is indicated by the interrupt), this interrupt is deactivated again in order to prevent the interrupt sequence from being called up a second time.

In a subsequent fifth step S5, the signal edge identification or the interrupt edge trigger of the microcontroller pin is reconfigured based on the current rotor position sector (rising or falling edge) such that the BEMF zero crossing can be detected. The interrupt is then activated again.

If a BEMF zero crossing is identified by the interrupt, the first step S1 is executed again. The sequence of steps S1 to S5 is preferably repeated for as long as the BLDC motor is operating in the BEMF zero crossing mode.

As long as the sequence of steps S1 to S5 is proceeding, the signal path of the microcontroller, which signal path is connected to the active comparator (associated with the non-energized motor phase), is preferably periodically switched over between the input mode and the output mode (cf. FIG. 3C). It has been found to be advantageous if this switching over takes place synchronously with the PWM carrier signal of the motor controller and as a function of the duty cycle of the motor controller.

LIST OF REFERENCE SIGNS

| | |
|---|---|
| 10, 20, 30 | Comparator |
| 80 | Microcontroller |
| 100 | Circuit arrangement |
| R1 . . . R9 | Ohmic resistors |
| GPIOA, GPIOB, GPIOC | Signal paths of the microcontroller |
| VADIV, VBDIV, VCDIV | Terminal voltages of the BLDC motor |
| VK1, VK2, VK3 | Comparator signal at the output of the |
| | comparator |
| VSTAR | Star point voltage of the BLDC motor |
| S1 . . . S5 | Method steps |
| AM | Output mode |
| EM | Input mode |
| KB | Short-circuit range |
| SF1 | First signal edge |
| SF2 | Second signal edge |

What is claimed is:

1-12. (canceled)

13: A method for operating a circuit arrangement as part of a BEMF zero crossing identification operation serving as a basis for sensorless commutation of a brushless DC motor, wherein the circuit arrangement has at least one comparator and a microcontroller, the comparator designed to compare a phase voltage or terminal voltage of the brushless DC motor with a star point voltage of the brushless DC motor and to output a corresponding comparator signal to a signal path of the microcontroller, the signal path being connected to the comparator and to a microcontroller pin, the method comprising:
periodically switching over between an input mode and an output mode the signal path of the microcontroller connected to the comparator and the microcontroller pin.

14: The method as recited in claim 13 wherein the microcontroller pin is configured as an input in the input mode in order to evaluate the comparator signal of the comparator for the BEMF zero crossing identification.

15: The method as recited in claim 14 wherein the microcontroller pin is configured as an output in the output mode to condition a level present at an edge detector of the microcontroller pin with a signal level.

16: The method as recited in claim 15 wherein when the microcontroller pin in the output mode, the signal path of the microcontroller and the comparator output signal have a same signal level being the signal level.

16: The method as recited in claim 15 wherein when the microcontroller pin in the output mode, the signal path of the microcontroller and the comparator output signal have a different signal level.

17: The method as recited in claim 13 wherein the comparator is arranged outside the microcontroller and an ohmic resistor is provided between a comparator output of the comparator, the comparator output outputting the comparator signal, and the microcontroller pin.

18: The method as recited in claim 13 wherein the switching over between the input and output mode takes place synchronously with a PWM carrier signal of the motor controller of the brushless DC motor or as a function of a duty cycle of the motor controller of the brushless DC motor.

19: The method as recited in claim 13 further comprising, as part of the sensorless commutation of the brushless DC motor, the following steps:
(S1) deactivating an edge-related interrupt trigger of the microcontroller or deactivating an external interrupt of the microcontroller pin associated with the signal path of the microcontroller of the motor terminal currently not energized if a commutation operation to be carried out is identified;
(S2) setting a new power switch combination for the brushless DC motor in order to be able to establish energization for the current rotor position sector of the brushless DC motor;
(S3) activating an associated interrupt;
(S4) deactivating the interrupt activated in the third step S3 as soon as it is identified that an inactive motor phase is de-energized; and
(S5) reconfiguring the interrupt trigger to either a rising or falling edge depending on the current rotor position sector to detect the BEMF zero crossing and activating the reconfigured interrupt.

20: The method as recited in claim 19 wherein, after successful detection of a BEMF zero crossing, the method steps S1 to S5 are repeated starting with the first method step S1, in particular for as long as the brushless DC motor is intended to be operated in a BEMF zero crossing mode.

21: A circuit arrangement for BEMF zero crossing identification in a brushless DC motor, the circuit arrangement comprising:
at least one comparator and a microcontroller, the comparator designed to compare a phase voltage or terminal voltage of the brushless DC motor with a star point voltage of the brushless DC motor and to output a corresponding comparator signal to a signal path of the microcontroller and to a pin of the microcontroller, the microcontroller pin being connected to the signal path, the microcontroller designed to periodically switch over the microcontroller pin associated with the signal path between an input mode and an output mode.

22: The circuit arrangement as recited in claim 21 wherein the comparator is arranged outside the microcontroller and an ohmic resistor is provided between a comparator output of the comparator, the comparator output outputting the comparator signal, and the microcontroller pin is connected to the signal path.

23: The circuit arrangement as recited in claim 21 wherein the comparator is arranged within the microcontroller and an ohmic resistor is connected upstream of a comparator input of the comparator.

24: An electric handheld power tool comprising:
a brushless DC motor; and
a circuit breaker combination for sensorless commutation of the brushless DC motor, the circuit arrangement at least temporarily executing he method as recited in claim 13.

25: The electric power tool as recited in claim 24 wherein the brushless DC motor is a three-phase motor.
